(19) United States
(12) Patent Application Publication
(10) Pub. No.: US 2009/0165132 A1
(43) Pub. Date: Jun. 25, 2009

(54) SYSTEM AND METHOD FOR SECURITY AGENT MONITORING AND PROTECTION

(75) Inventors: Rahul Jain, Bangalore (IN); Blair Nicodemus, North Wales, PA (US)

Correspondence Address: WOLF GREENFIELD & SACKS, P.C., 600 ATLANTIC AVENUE, BOSTON, MA, 02210-2206, US

(73) Assignee: FIBERLINK COMMUNICATIONS CORPORATION, Blue Bell, PA (US)

(21) Appl. No.: 11/962,235

(22) Filed: Dec. 21, 2007

(51) Int. Cl. G06F 21/24

(52) U.S. Cl. 726/22

(57) ABSTRACT

A security agent monitoring and protection system is provided. A security agent on an end point computing device can be accompanied by or can load into the device's memory at startup one or more independent software processes whose primary function is to directly protect the security agent itself and take protective actions against the end point computing device should a security agent protecting the device become disabled. Protection of the security agent can be achieved in several ways, including installing the security agent with restricted permissions, making it difficult to shutdown, restarting the security agent automatically if it is halted without authorization, disabling network connectivity of the end point device if the security agent does not successfully start or restart, protecting executable and dynamic link library (DLL) files of the security agent, and controlling access to the security agent's Common Object Model (COM) interfaces. These protective aspects can also be used by the monitoring agent itself to protect it from unauthorized access or disabling, further providing protection to the device.

### TECHNICAL FIELD

Aspects and features described herein relate to a system and method for monitoring and protection of a security agent on an end point computing device.

### BACKGROUND

The industrialized world is becoming increasingly dependent on computers and networks. While computing devices and data communications networks help make businesses and people more efficient by enabling users to obtain, process, and share information, our increasing dependency on them can also present special security challenges.

One of these challenges is ensuring the availability of computing devices and networks, and the data which is entered into, accessed from, stored on, or moved between different computing devices over the network.

Another security goal for computers and networks is ensuring the integrity of these computing devices and networks and all the details and data relating to the transaction, including the identity of the originator, the intended destination (person, process and/or computing device), date, and time of the transaction and transaction-specific information such as credit card number, item ordered, and mailing address.

Another security goal for computers and networks is ensuring confidentiality relating to computing devices and networks and the data relating to or stored on these computing devices and networks, such as online bank account balances, account numbers, login IDs, and passwords.

As described above, people and organizations frequently have a need or desire to ensure confidentiality, availability and/or integrity of computing devices, data networking devices, and/or the data stored on those devices. Unfortunately, people and organizations exist that have an explicit goal of accessing and examining confidential information, disrupting availability of computing or networking devices, performing unauthorized modifications to legitimate electronic transactions and/or electronically stored data, and/or creating illegitimate electronic transactions and/or electronically stored data. Such activities are collectively referred to as “computer attacks,” “network attacks” or simply “attacks” hereafter. An attack may target the availability, integrity and/or confidentiality of computing systems, network devices, and/or data.

One particular security attack scenario that has caused widespread concern is one where an end point becomes infected with malware at a given location and the end point is subsequently brought to a different location where the end point is then connected to the network. Once connected to the network, the infected end point could then attack or spread its malware to computing devices or networking devices directly or indirectly reachable over the network.

For this reason, individuals and organizations often install and operate computer and network security products designed specifically to protect computers, network devices or data from attackers and from attacks. Large organizations often spend considerable amounts of money to purchase commercial end point and network security products and invest considerable amounts of manpower to keep security agents and security hardware configured correctly, kept up to date, perform continuous monitoring, etc. These may be specialized hardware devices such as a firewall or secure email gateway, or alternatively may be specialized computer programs that run on general purpose operating systems such as Microsoft® DOS, Microsoft Windows®, PalmOS®, Microsoft WindowsCE®, Symbian®, Linux®, UNIX®, BSD®, etc.

Security applications are typically explicitly designed by the product designer to run on an end user's personal computing device, e.g. laptop computer, smartphone, PDA, etc. These computing devices will hereinafter collectively and generically be referred to as “end point computing devices,” “end points,” “personal computers,” or “personal computing devices.” Special purpose computer security programs designed to run on an end point computing device will hereinafter collectively and generically be referred to as “security agents” or “agents.” Security applications may alternatively be specifically designed and intended to run on a server computer accessed or used by multiple users, e.g. a mail server, web server, network print server, network file server, etc. The goal of all these security applications is to protect end point computing devices and servers from attacks.

There are a wide variety of security agents available for protecting end points and servers. The features and characteristics of these products vary depending on the security problem or problems the designer is trying to solve.

Examples of commonly used end point security applications include but are not limited to: antivirus security agent, personal firewall, anti-spyware security agent, disk encryption agent, hardware device (e.g. USB drive, optical drive) protection agent, data backup agent, IPSec VPN client agent, SSL VPN client agent, intrusion protection agent, patch management agent, hardware inventory management agent, software inventory management agent, etc. Some available products may have several security features that cause them to be functionally equivalent to two or more of the types of security agents just listed. For example, a security agent that simultaneously provides antivirus and firewall capabilities. Some available products operate in a simple, standalone fashion having no user controls. Some products provide configuration settings that can be used to control their behaviors or to enable/disable various features and behaviors. Some products permit the direct user of the computing device to make configuration changes. These are commonly referred to as “standalone” security agents. Some products permit an IT administrator in an organization to centrally define configuration settings for the entire user population or a subset of the user population. Configuration settings defined on a central management console are subsequently distributed out to the individual computing devices on which the security agents are running and are thereafter used by the security agent. Software distribution can be accomplished via a number of well known methods. These are commonly referred to as “managed” security agents.

Generally, the security agents installed on end points work as advertised and provide the expected level of protection. However, there are many situations in which a group of seemingly well-protected end points, servers and networking device, either in a standalone or interconnected mode, may not provide adequate protection.

For example, a visitor or member of the organization may need to plug their personal computing device into the organization's wired or wireless network, but the visitor's computer does not have appropriate security agents installed or they are out-of-date, disabled, or misconfigured. Alternatively, a visitor or member of the organization may have accidentally or intentionally changed a configuration setting on a security agent, causing it to no longer provide certain types of protection, or may even have accidentally or intentionally removed or otherwise disabled an installed security agent, causing it to no longer provide any protection. Another vulnerability can arise if a conflict between the security agent and the operating system or the security agent and another computer program installed on the end point results in the security agent not functioning completely, properly or causing it to be completely inoperable.

In all of these cases, the end point security agent does not provide the level of protection needed or expected by the organization, and the end point is therefore vulnerable to attacks or may already have been attacked. No matter how they are accomplished, such malware attacks can have considerable operational and financial consequences to an organization, including the costs to remove the malware from all impacted end points, servers and networking devices, the costs of data loss or data recovery, lost business due to unavailability of critical computers or data, disruption to normal business operations while cleanup operations are underway, etc.

Clearly, the potential damage resulting from a disabled security agent can be significant and result in significant operational disruption and result in significant financial loss.

A modern, multi-user operating system running on a computing device ultimately controls read, write and execute permissions on files stored on the computing device's data storage component. Such an operating system also controls access to running processes. The standard solution to prevent intentional or accidental disabling of a running process is to leverage these existing security facilities that already exist in multi-user operating systems. Specifically the operating system should be configured such that only user accounts with appropriate privileges and only other software processes with appropriate privileges should thus be able to invoke any action against the security agent process. This procedure is a commonly accepted approach to this problem.

The problem and limitation with this approach is that an operating system thus configured makes it difficult or altogether impossible for users of the computing device to install needed software applications, remove unneeded software applications or change certain configuration settings in the operating system. This presents a problem in large organizations that need to manage large numbers of end user computing devices. When the end point operating system and configuration is “locked down,” i.e. not configurable by the end user, a centralized staff of computer administrators with a high set of privileges must perform all software installations, upgrades, removals and configuration changes. This presents a significant labor effort and cost that is directly proportional to the number of computing devices being administered.

Because of the costs and complexity of maintaining tight, centralized control over end point computing device configurations and settings, most large enterprises do not in fact utilize this approach. Instead, in order to reduce the cost and complexity of centralized administration, they issue to end users personal computing devices that are usually not “locked down,” and thus enable the users to install, reconfigure or uninstall software as they see fit. Specifically, these organizations make a conscious decision to not enable or utilize security features available in modern, multi-user operating systems explicitly meant to restrict access to running processes and stored files. In so doing, while they effectively delegate much end point software administration to end users and reduce central administration costs, they also produce a situation where there are no longer adequate protections on security agents and where it is thus possible for an end user, attacker, OS action or software conflict to disable the security agent responsible for protecting the end point from attackers and attacks.

What is needed is a solution that provides organizations the protection they need for the security agent itself, while simultaneously allowing the organization to allow loose configuration management of the end point computing device itself There is no readily available or obvious solution to this problem.

U.S. Pat. No. 5,491,791 to Glowny et al. describes a system and method for inventorying and monitoring a remote workstation within a distributed computing environment. A diagnostic routine is executed at a remote workstation for monitoring a configuration characteristic of the remote workstation and for providing a report regarding that characteristic to the monitor workstation for analysis, including compilation of an appropriate report and possible issuance of an alert message.

U.S. Pat. No. 6,874,087 to Fetkovich et al. describes a method, system, and computer program for monitoring the integrity of an executable module and an associated protected service provider (PSP) module, where the PSP module provides a protected service function to the executable module. Monitoring is performed by a monitor entity which is separate from the PSP module and which cannot easily be detected or defeated. If the integrity checking reveals that the integrity of the PSP has been or is about to be compromised, certain defensive actions can be taken to protect the integrity of the PSP.

U.S. Pat. Nos. 7,152,185 and 7,233,989 to Srivastava et al. describe a Node Manager which monitors the status of multiple servers on a computer network. The Node Manager detects server failures, periodically monitors server health status, and performs server maintenance. When the Node Manager detects a server failure, it determines whether or not the server should be restarted.

U.S. Patent Application Publication No. 2006/0010492 to Heintz et al. describes methods and systems for monitoring activity of a user on a network component, such as an end user computer, in a virtual private network for adherence to a security enforcement provision or policy utilized in the virtual private network. If the network component has violated, modified, or circumvented a security enforcement provision of the network, the network component is modified in a manner such that the computer network operates at a level appropriate to the degree of the violation, modification, or circumvention of the security enforcement provision.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects and features described herein relate to software applications that can run on a computing device and that can be highly resistant to attempts to shut down the application. Features described herein can comprise several discrete design steps that can be combined to result in a highly resilient software application that is difficult to shut down or disable and that can be automatically restarted should such an event actually occur.

According to other aspects, a software application monitoring and protection system in accordance with aspects described herein can enable a software application to be accompanied by, or load into memory on startup, one or more independent software processes whose primary function is to directly protect the software application itself and to further take protective actions directly against the end point computing device should a security agent protecting the device become disabled.

Protection of the software application in accordance with aspects described herein can be achieved in several ways, including the security agent with restricted permissions, making it difficult to shutdown the software application, restarting the software application automatically if it is halted without authorization, disabling network connectivity of the end point device if the software application does not successfully start or restart, protecting executable and dynamic link library (DLL) files of the software application, and controlling access to the software application's Common Object Model (COM) interfaces.

### BRIEF DESCRIPTION OF THE DRAWINGS

FIG. 1 is a block drawing of an exemplary configuration of an end point computing device having a security agent monitoring system and process in accordance with one or more aspects described herein.

FIG. 2 depicts an exemplary logic flow for monitoring and protecting file permissions relating to a security agent in accordance with one or more aspects described herein.

FIG. 3 depicts an exemplary logic flow for monitoring and protecting a security agent running status in accordance with one or more aspects described herein.

FIGS. 4A and 4B depict an exemplary logic flow for validating the authenticity of software modules of a security agent in accordance with one or more aspects described herein.

FIG. 5 depicts an exemplary logic flow for mutual verification of software modules by two software applications in accordance with one or more aspects described herein.

FIG. 6 depicts an exemplary logic flow for application blocking in the event of a failure of a security agent in accordance with one or more aspects herein.

FIG. 7 depicts an alternative exemplary logic flow for application blocking in the event of a failure of a security agent in accordance with one or more aspects herein.

FIG. 8 depicts an exemplary logic flow for connectivity blocking in the event of a failure of a security agent in accordance with one or more aspects herein.

### DETAILED DESCRIPTION

The aspects summarized above can be embodied in various forms. The following description shows, by way of illustration, combinations and configurations in which the aspects can be practiced. It is understood that the described aspects and/or embodiments are merely examples. It is also understood that one skilled in the art may utilize other aspects and/or embodiments or make structural and functional modifications without departing from the scope of the present disclosure.

For example, certain aspects and features of a system and method for monitoring and protecting a software application are described herein in the context of a security application, as this class of software application is known to be a direct target of security attacks. However, it should be noted that aspects and features described herein can be used to monitor and protect any other software application where continued uptime is deemed important and where resiliency to attacks or unexpected outages is desired, and would be just as valued and beneficial in that situation. In addition, although aspects and features herein are described in the context of a computing device or a computer network operating on a Microsoft Windows® platform, one skilled in the art would understand that the methods and systems herein may easily be modified to function with computing devices or computer networks under other operating systems such as APPLE® OSX Leopard, UNIX®, Linux®, BSD®, Symbian®, Windows Mobile®, Palm OS®, or any other operating system.

When an operating system does not offer adequate controls to protect a security application or other application requiring continuous operation, that application can be at risk of unauthorized, accidental, or unexpected disabling. When an operating system does offer such adequate controls, but those controls are not utilized, applications are similarly at risk of unauthorized, accidental, or unexpected disabling. If an application is disabled, it may no longer able to perform or fulfill its intended purpose, the consequences of which are dependent on the type of application and how it is used. If a security application that is protecting the end point computing device is disabled, it may no longer able to properly protect the end point computing device from threats, attacks, and malware, thereby exposing the end point computing device to direct attacks and creating a risk that a compromised end point computing device will be used as a base of further attacks on private or public networks to which the computing device connects. A solution in accordance with one or more aspects described herein can protect a security application running on a computing device to ensure that it is able to run continuously as desired, even when an operating system on which the application is running is not able or is not configured to directly protect the application.

In accordance with aspects described herein, if the operating system does not provide adequate protection for the security agent, the security agent can protect itself. For example, the security agent can provide a mechanism that prevents itself from being shut down or disabled, and should that event somehow occur, the security agent can provide an automated recovery mechanism that automatically restarts the security agent such that the security agent returns to normal operation. By providing a high level of resiliency in the security agent itself, the organization can be assured that the security agent is running at all times and performing its intended function.

Additionally, in accordance with aspects described herein, the security agent can be accompanied by or include separate logical components dedicated to monitoring the state of the security agent and automatically restarting the security agent should it become disabled for any reason. The dedicated monitoring process can also provide an ability to execute a variety of protective actions to protect the end point from security attacks when the security agent is disabled. Since such a monitoring process would itself also be a likely target of security attacks, in accordance with aspects described herein, the process can have some stealthy properties that make it difficult to detect, difficult to identify as the security agent's protector, and/or difficult to stop.

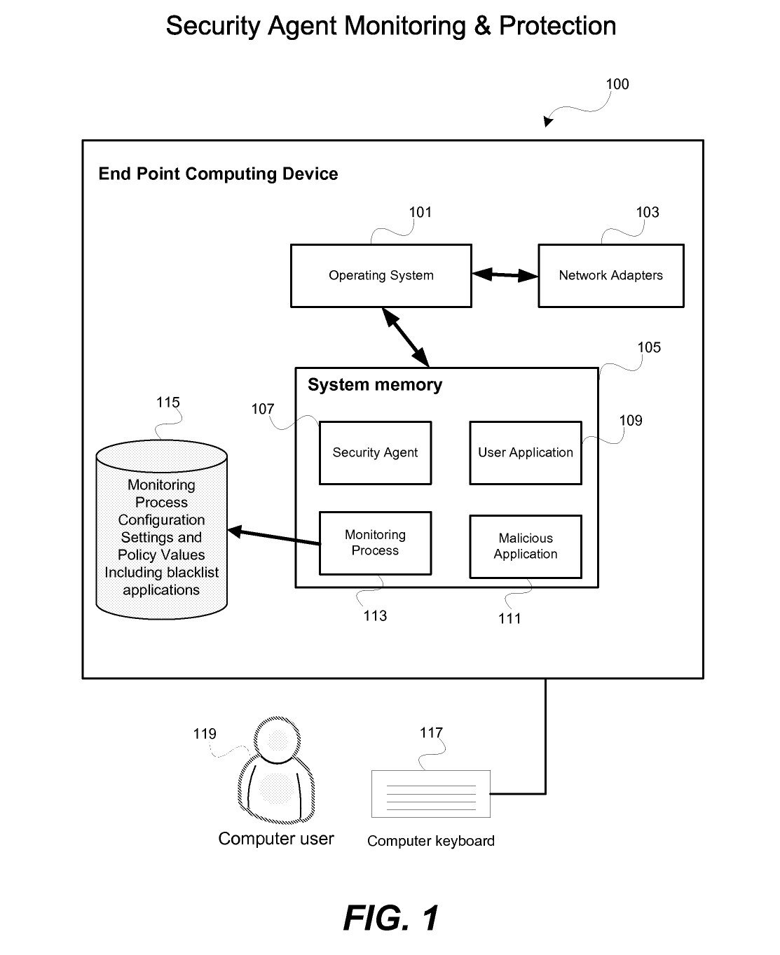

FIG. 1 depicts an exemplary configuration of an end point computing device having a security agent and security agent monitoring and protection in accordance with one or more aspects described herein. In the exemplary configuration shown in FIG. 1, end point computing device 100 can include an operating system 101 that is operatively connected with one or more network adapters 103 and a system memory 105. System memory 105 can store within it information regarding various aspects relating to the end point computing device. For example, system memory 105 can store within it information regarding one or more user applications 109 which can be accessed by computer user 119 via a computer keyboard 117 connected to end point computing device 100. In addition, end point computing device 100 can have a security agent 107 resident in memory 105. As described above, security agent 107 can include, for example, a firewall application or antivirus application to protect end point computing device 100 from unauthorized access or other attacks from the outside or to protect an outside computing device from being infected by end point computing device 100 if such infection or other vulnerability does occur.

Although it is generally undesirable for there to be one or more malicious applications 111 running in system memory 105 on an end point computing device 100, this may occur as a result of a security attack against the end point computing device 100. A malicious application may attempt to disable or otherwise disrupt a security application 107 or another user application 109 that is desirable to have running continuously. In accordance with aspects and features described herein, monitoring process 113 can be used to protect the security application 107 or another user application 109 that is desirable to have running continuously in the event of such an attack by a malicious application 109, by an intentional act of a computer user 119, by an unexpected event within the operating system 101, and/or by some other act or event.

In addition, in accordance with one or more aspects and features described herein, memory 105 can include a monitoring process 113, described in more detail below, which can monitor and protect a security agent on computing device 100 and which can take remedial actions to protect computing device 100 in the event that a security agent fails. In accordance with aspects and features described herein, monitoring process 113 can protect the security application 107 or another user application 109 that is desirable to have running continuously in the event of such an attack by a malicious application 109, by an intentional act of a computer user 119, by an unexpected event within the operating system 101, and/or by some other act or event. Monitoring process 113 can also be operatively connected to a data repository 115, which can contain configuration settings and policy values that can be used by monitoring process 113 to monitor and protect the security agent and configuration settings and policy values such as a list of blacklisted applications that can be used by monitoring process 113 to protect computing device 100 in a manner described in more detail below.

In one embodiment of a security agent monitoring and protection system and method in accordance with aspects and features described herein, monitoring and protection of a security agent on an end point computing device can be accomplished through the use and management of executable privileges relating to the security agent.

In accordance with software methods and features known in the art, every software application running on a computing device and every file stored on a computing device has certain privileges. When the software application is installed, or on startup, the file permissions can be set such that while a user or external software process can view the file or query the running status of the software application, it should not be possible for an external user or software process to delete the file or process. Since renaming a file makes it impossible for related processes to find the file of interest, privileges can also be set such that it should not be possible for an external user or software process to rename the file or process.

The details of how the privileges are defined are specific to each operating system and can be achieved using several possible approaches. For example, the Microsoft Windows XP® operating system calls these privileges Access Control Lists (ACL). ACLs can be used to control which users can access, modify and/or delete files residing in a Windows XP® operating system file system. The current ACL for a file can be viewed and/or modified by selecting the file in the graphical user interface, then right clicking with a mouse and selecting Properties, then selecting the Security tab, and then selecting or deselecting Allow and Deny selection boxes for one or more file permissions such as Full Control, Modify, Read & Execute, Read, Write. This approach would normally be used by an end user wishing to modify file settings. Similar functionality and additional file properties are available via a command line interface using the ATTTRIB command. For example the command “ATTRIB+H firewall.exe” would cause the Windows operating system to SET the HIDDEN attribute for the executable program firewall.exe. Thereafter, when viewing a directory of files, the firewall.exe file will not ordinarily be included in the results, because it is being hidden by the operating system. The command line approach would normally be used by a malicious application wishing to modify file settings. Similar file privileges, file access permissions, or file access control list capabilities exist in other operating systems. For example, in Linux®, the CHMOD command is comparable to the Windows XP® ATTRIB command and can be used to set file privileges.

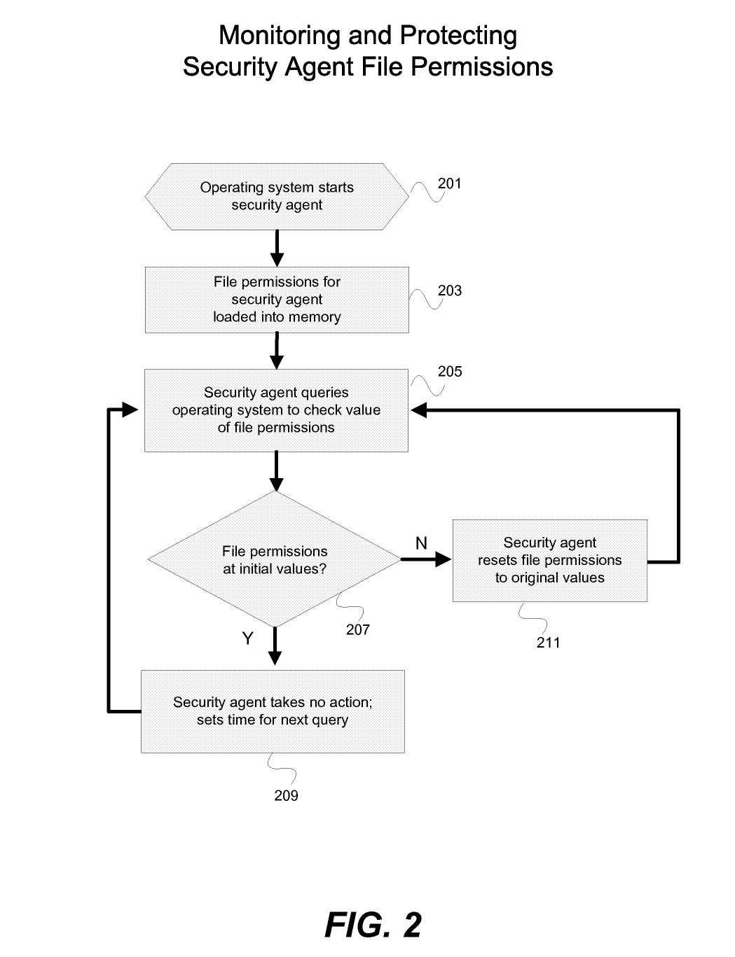

As shown in FIG. 2, in accordance with one or more aspects described herein, a security agent residing on an end point computing device can periodically query the operating system to check the value of file privileges relating to the security application, and if they are found to have been changed from their initial values, the security agent can reset the privileges back to the preferred security values. For example, at step 201 the operating system running on the end point computing device can start a security agent such as a firewall application, antivirus application, or other application designed to protect the computing device from malware or other attacks as described above. As part of the initialization process for the security agent, at step 203 file permissions for the security agent are loaded into memory in the device. As noted above, these file permissions can determine whether the security agent can be started, stopped, modified, or otherwise affected by actions of a user of the device.

At step 205, the security agent can query the operating system to check the values of the file permissions stored in memory. As stated above, although specific file permissions and their nomenclature can vary by operating system, they can be generalized as read, write, and/or execute. At step 205, the security agent can check the file permissions to ensure that an “execute” permission is enabled and to ensure that a “write” permission is not enabled. Depending on the operating system, a “read” permission can also be checked to verify it is enabled. Depending on the operating system, other file permissions can also be checked to verify they are enabled or disabled.

At step 207, the security agent can receive the results of the query from the operating system and can check to see whether any of the file permissions values have changed. If they have not changed, then at step 209, the security agent takes no action and can set a time for the next query and the process begins again. However, if the value of any of the file permissions has changed, at step 211, the security agent can reset the value of that file permission to the original values loaded into memory when the security agent was initialized. Once the proper values of the file permissions have been set, the security agent can set a time for the next query so that the monitoring process can be repeated.

Another example of a permission associated with an application is the permission to stop an application after it has begun running. As described below, monitoring and protection systems and methods in accordance with one or more aspects described herein can prevent an unauthorized stoppage of a security agent running on an end point computing device.

As is known in the art, some operating systems, such as Microsoft Windows 2000®, Microsoft Windows XP® and Microsoft Windows Vista®, define two types of software processes: services and applications. A service is generally a software process that is running from system startup to system shutdown. Its running state is controlled by the operating system. An application is generally a software process that does not run until an end user initiates the process, and continues running until the user halts it. Its running state is controlled by the end user of the computing device. A security agent running on an end point computing device is typically a service, so that it provides continuous end point protection from startup to shutdown. In accordance with aspects herein, the security agent can be protected from unauthorized commands, either from the user or from malware, that might compromise or otherwise adversely affect the security agent's ability to protect the device from malware or other security threats.

In accordance with aspects known in the art, operating systems that support services and similar persistently running processes typically provide mechanisms by which a software process can register or configure its desired properties and authorized actions. For example, Microsoft Windows® operating systems that support services provide a service management console to manage the service. Actions such as Start, Stop, Configure, etc. are possible with this service management console. When the software to be protected is installed, the software process registers a set of permitted and denied actions or controls the software process supports with the operating system using the service management console. In accordance with one or more aspects described herein, the protected software, such as a security agent as described herein, can register “Stop” as a denied action. Because “Stop” is a denied action, the operating system will actively disregard external attempts to stop the software process once it has started running. For example, in the case of a Microsoft Windows® operating system, a user or attacker opening the services administrative console to take action with respect to the security agent will not see “Stop” as an option for the security agent, making it impossible for a user or an attacker to halt the process using this method.

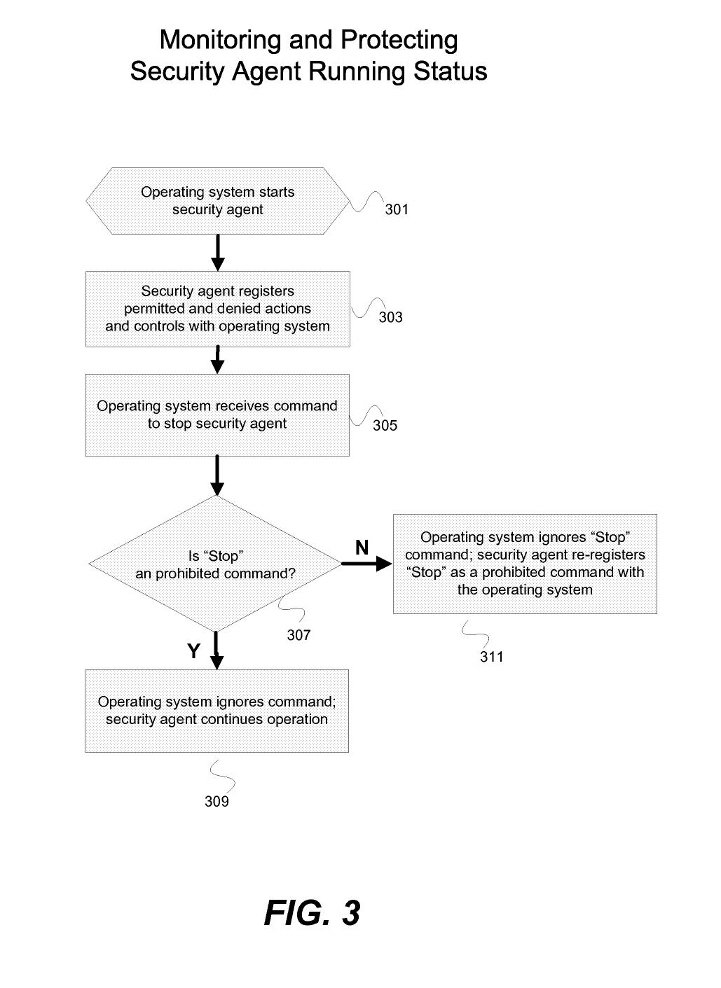

An exemplary logic flow used by the operating system in accordance with a these aspects is shown in FIG. 3. At step 301, the operating system, for example, a Windows® operating system operating on an end point computing device, can start the security agent on the device. At step 303, the security agent can register a set of permitted and denied actions or controls with the operating system, for example using the operating system's service management console. At step 305, the operating system can receive a command from a user to take some action with respect to the security agent, for example, a conventional process kill command to the operating system such as “net stop <process ID>” in a Windows® operating system, or “kill <process ID>” in a Linux® operating system. For simplicity in the discussion herein, such a command will simply be referred to as a “stop” command. At step 307, the operating system can query the service management console to see whether the “stop” command has been registered by the security agent as a prohibited command. If the answer to this query is “yes,” then at step 309 the operating system will ignore this command and the security agent will continue running. If, however, the answer to this query is “no,” then at step 311 the security agent can not obey the stop command but instead can re-register the “stop” command as a prohibited command with the operating system. In this way, even if the registration of “stop” as a prohibited command is somehow circumvented, the security agent will continue to ignore the “stop” command so that it continues to run and protect the device. Similar operating system commands normally used to halt running executables can similarly be blocked using this approach.

In addition, in a manner similar to that shown in FIG. 2, a security agent monitoring and protection system in accordance with one or more aspects described herein can periodically check to ensure that a prohibited action, for example, a “stop” action, remains a denied action for the security agent such that the security agent cannot be stopped. If, however, the “stop” is not among the prohibited actions as registered with the operating system, in accordance with aspects and features described herein, the security agent can re-register “stop” as a prohibited action even before the operating system receives a “stop” command to ensure that the operating system will not inadvertently obey such a command and stop the security agent, leaving the device vulnerable to attack.

In some circumstances, however, in spite of best efforts and innovative hardening approaches such as those described above, a security agent running on a computing device can still be running in a loose, unsecured operating system. Because of this, a determined user, determined attacker, or errant process still could successfully shut down the security agent process, and thus the end point computing device could still remain vulnerable to additional security attacks.

To address this risk and to prevent such security attacks, a security agent monitoring and protection system and method in accordance with one or more aspects described herein can include a supplemental software program specifically designed to monitor the running state and health of the security agent, to try and restart or restore the security agent in the event it becomes disabled, and further to take palliative actions that can protect the end point from security attacks or render it largely unusable in the event the security agent becomes disabled. In accordance with aspects described herein, a dedicated mechanism focused on protecting the security agent and on neutralizing the end point computing device in the event of a disabled security agent can be operated on the computing device to protect both the security agent and the computing device from attacks. A dedicated software component on the computing device that can perform monitoring of the security agent and other actions as described herein will hereinafter be referred to as the “monitoring process.”

In accordance with one or more aspects described herein, a monitoring process can be included as part of the security agent installation process and installed on the computing device at the same time as the security agent is installed. Alternatively, the monitoring process can be installed on the computing device after the security agent is installed. Installation details will vary by operating system and installation can be performed in a number of different ways.

When the security agent itself is first started, the security agent can load into memory subsequent modules and processes that it needs to fully operate. The monitoring process can be one of the processes loaded by the security agent and started when the security agent itself is started. Alternatively the monitoring process can be registered separately with the operating system such that the monitoring process is automatically started when the operating system loads. Several alternative approaches exist in the art in which a monitoring process in accordance with aspects described herein can be recognized by the operating system as a process that should automatically be loaded when the operating system loads. Both the spawn approach and the independent load/startup approach can be used with methods and systems for monitoring and protection of a security agent described herein. It should also be noted that other approaches to starting the monitoring process are possible as well. The details of each of these approaches will vary by operating system and programming language, but any appropriate approach can be used to launch security agent monitoring and protection methods and apparatus as described herein.

A primary focus of a monitoring process as described is to monitor the status and health of the security agent. This can be accomplished in a number of ways. For example, the list of processes running on a device can be inspected using an operating system facility known in the art.

Alternatively, a configuration setting or dynamic parameter maintained by the security agent can be examined, for example, the security agent may start a process that does nothing more than automatically exit after 60 seconds. If the security agent re-launches the process every 60 seconds, the monitoring process specifically designed to monitor this short-lived process can monitor whether the process is active and if not assume that the security agent is no longer operating correctly.

A third monitoring method can be accomplished through the use of a direct programmatic interface (e.g. an API), for example the security agent has an API through which a monitoring process specifically designed to support that API can submit a health status inquiry to the security agent. Every 60 seconds, or at an alternate, administratively defined or programmatically defined interval, the monitoring process may send a health status inquiry to the security agent via the API and await a response message indicating the security agent's current health level. If the security agent is not running, the monitoring process will receive no response to its health status inquiry, and can thus assume that the security agent is no longer operating correctly. Alternative methods of determining whether or not a process is active exist for different operating systems are also possible.

In such a fashion, the monitoring process can simultaneously monitor a variety of different security agents, restart any security agent should it become disabled, and/or take one or more palliative actions as described herein should a monitored security agent become disabled. A configuration file containing the necessary data parameters, hard-coded parameters, or an alternative mechanism can be used to enumerate the security agents to be monitored, the details regarding how the monitoring should be performed (e.g. running process and process name, inspecting a dynamically updated parameter and the corresponding Microsoft Windows® Registry Key name, API method and class to invoke, etc.), and the details regarding how to restart the security agent (e.g. operating system command, executable name, etc.).

In accordance with one or more aspects described herein, if the monitoring process detects that one or more security agents of interest are no longer active, the monitoring process will try to restart the security agent process. This is achieved by sending an appropriate command to the operating system requesting an executable process to be initiated and specifying the executable process by name. The details of how this action is performed varies by operating system.

In an embodiment of a security agent and monitoring process in accordance with one or more aspects described herein, there can be provided monitoring and protection of the software components, known as “modules,” that make up the security agent. A simple, limited functionality software program often comprises only a single software module. However, this is rarely true for a sophisticated computer program such as a security agent. Sophisticated software programs that perform many functions are often designed as a suite of separate, but interfacing software modules that communicate bidirectionally with each other as needed. The notion of modularity and well defined interfaces between software components is a fundamental tenet of software engineering methodology.

One way of disabling a security agent or rendering it inoperable and hence ineffective is by causing the security agent to load a malicious module.

In multi-component software programs, there is usually a central core component that is loaded by the operating system first, and the central component then loads other modules as needed. The invocation method varies by operating system and a number of methods are possible. For example, a widely used approach for componentizing software programs that run on the Microsoft Windows operating system is to use what are called Dynamic Link Libraries (DLLs). If the end point operating system configuration is not locked down to protect every individual DLL and the folder in which the DLL files are stored, an attacker could easily replace a DLL with a substitute DLL having a malicious design.

For example, a malicious DLL could inject random garbage into a software module which could cause the security agent to freeze. Alternatively, a malicious DLL could send a command string that, although valid, could cause the security agent to take some action which would reduce the security posture of the end point computing device, such as disabling one or more of its own security settings. Alternatively, a malicious DLL could send a command that would cause the security agent to disclose sensitive information, confidential information, or security agent configuration settings; such information can be used by an attacker for subsequent attacks. Combinations of the above attacks and other forms of attacks are of course possible.

Conversely, when a DLL (or other form of software component that is part of a multi-component software application) is loaded, how does the DLL or component know that it is being loaded by an authorized application, i.e. the central component? If the end point operating system configuration is not locked down to protect every individual software component and the folder in which the software component files are stored, an attacker could easily replace a software component with a substitute software component having a malicious design. In such a situation, an attacker with a malicious software program could invoke a legitimate DLL (the legitimate DLL being unaware that it has been invoked by a program with malicious intent) and cause the legitimate DLL to take an action that would reduce the security posture of the end point computing device, e.g. change one of its own security settings, open up ports on a firewall, remove applications from a application blacklist, etc.

To prevent against an attacker from successfully having a malicious DLL loaded and used by the central component of the security agent, public key encryption and in particular digital signature technology can be used for DLL integrity and authenticity validation. Public key cryptography and digital signatures and their use in integrity and authentication are well understood in the industry and are not described in detail herein.

Validation of the DLL can be performed before the central component accepts any routine method calls from the DLL and before the central component sends any commands or data requests to the DLL. Similarly, in accordance with one or more aspects described herein, to prevent against an attacker from successfully having a legitimate DLL loaded and used by a malicious software component impersonating the central component of the security agent, public key encryption and in particular digital signature technology can be used for software component integrity and authenticity validation. In accordance with aspects herein, validation can be performed before the DLL accepts any routine method calls from the central component and before the DLL sends any commands or data requests to the central component.

In accordance with one or more aspects herein, each software component of a security agent, including the central component and each DLL or software module loaded or used by the central component, can be embedded with a digital certificate. Upon loading of the component, both peer components (the invoking component as well as the invoked component) perform a mutual handshake and a mutual authentication of the peer's digital certificate. If the mutual authentication succeeds, normal operations and communications can proceed. If the mutual authentication fails, the side detecting the failure will block all further communications with the peer.

This self-protection concept can be extended downstream as necessary, i.e. if a DLL must load another DLL, the first DLL can validate the integrity and authenticity of the second DLL just as the central component validated the integrity and authenticity of the first DLL loaded. One skilled in the art would understand such extensions of this self-protection concept to be within the scope of the aspects and features described herein.

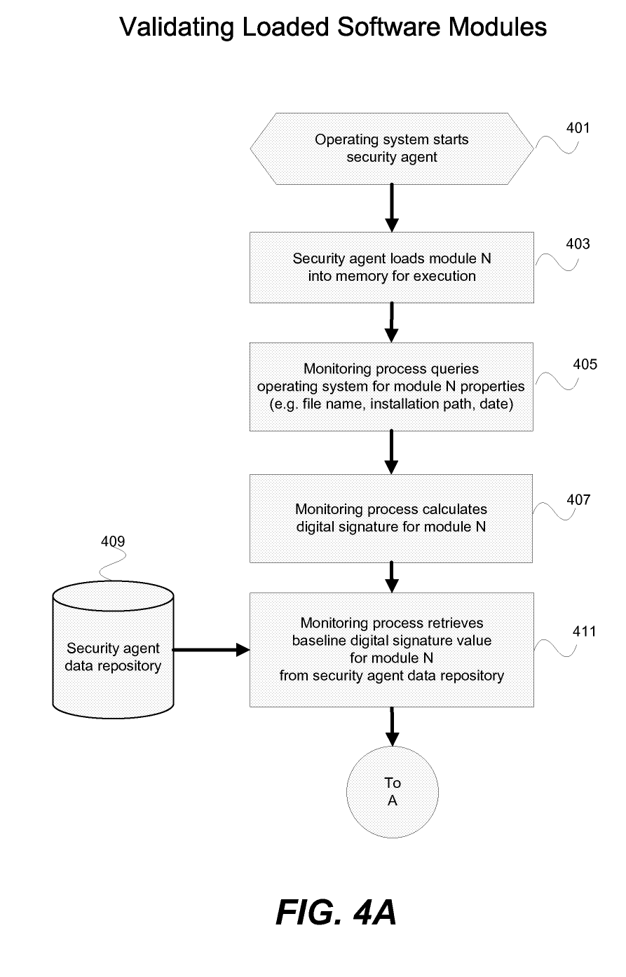

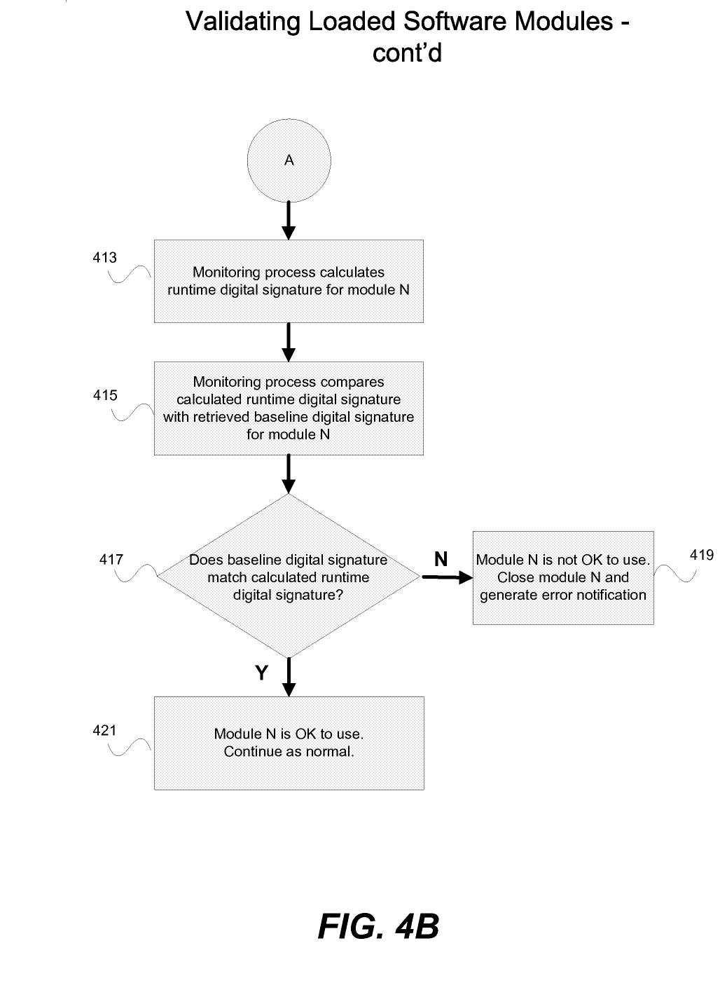

An exemplary logic flow for confirming the validity of a software module of a security agent in accordance with one or more aspects described herein is shown in FIGS. 4A and 4B.

As shown in FIG. 4A, at step 401, the operating system can start the security agent. This will usually occur when the computing device first starts up but can occur at other times during operation of the device as well. As noted above, the security agent can comprise a core component and a series of software modules in the form of one or more DLL files. At step 403, the security agent can load a software module N into memory for execution as described above. As described above, the component of the security agent loads module N into memory would be an “invoking component” and module N would be an “invoked component.” At step 405, the monitoring process can query the operating system for properties associated with software module N, such as a file name, installation path, date created, or date modified. At step 407, the monitoring process can calculate the digital signature value for software module N so that the mutual handshake and mutual authentication of the digital certificate by the invoking and invoked components can be performed as described above. At step 411, the monitoring process can retrieve a baseline digital signature value for software module N from security agent data repository 409, which can store valid digital signature values for all software modules of the security agent

As seen in FIG. 4B, at step 413, the monitoring process can calculate a runtime digital signature value for software module N. At step 415 the monitoring process can compare the calculated runtime digital signature calculated at step 413 with the retrieved baseline digital signature for software module N calculated at step 411, and at step 417 can determine whether the baseline digital signature matches the runtime digital signature. If the baseline digital signature matches the runtime digital signature, then at step 421, the monitoring process can determine that software module N is okay to use and the security agent continues operation as normal. If, however, the baseline digital signature does not match the runtime digital signature, at step 419, the monitoring process can determine that software module N is not okay to use. In such a case, the monitoring process can close software module N and generate an error indication. The resulting error indication may be used to trigger display of a message in a graphical user interface indicating to an end user that the security agent has experienced a critical operational error due to the presence of an invalid or unusable software component (e.g. a DLL). Additionally, the resulting error notification may be used to take remedial actions to protect the end point computing device in a manner described in more detail below.

The preceding describes an embodiment where a DLL is the software module being loaded and digital certificates are the peer authentication method used. As was described, a similar authentication process could also be used for mutual authentication of other types of software components. On Microsoft Windows operating systems, one method by which software components can communicate is via what are known as Component Object Model (COM) application programming interfaces (APIs).

In accordance with methods known in the art, a software component that has a COM interface can register itself with Windows Running Object Table (ROT) on the end point computing device. This procedure is well-defined in published Microsoft Windows software developer documentation and is not elaborated on herein. A second software component needing to communicate with the first software component via the COM interface queries the ROT to obtain a reference to the COM interface, enabling the second software component to then initiate direct communications with the first software component via the COM interface.

Because the COM interface is exposed during this communication between software components, an attacker or user could write a malicious program that accesses the central component of the security agent. This creates a vulnerability and risk to the security agent and to the security of the computing device similar to that previously described herein in the context of DLLs.

To avoid this vulnerability, a system and method for monitoring and protection of a security agent residing on an end point computing device in accordance with aspects and features described herein can use an alternative method of mutual authentication.

In one embodiment, a main software component for a security agent can provide a COM application programming interface (API) for use by a second software component specifically designed to provide a user interface for the security agent. The user interface is the portion of the security agent actually observable to a user of the computing device. A user interface for a security agent on an end point computing device in accordance with aspects herein can provide status information about the security agent, display configuration settings for the security agent, and/or provide a mechanism by which a user of the computing device can change one or more of those configuration settings.

To prevent a malicious program from obtaining a reference to the security agent's COM interface, the security agent provides a three-step handshake process to authenticate the requester of COM interface services as a prerequisite to providing its interface reference to the requester, and hence as a prerequisite to normal communications between the security agent and the requester. Numerous cryptographic algorithms are possible for an authentication mechanism in accordance with aspects described herein. It can be understood that different cryptographic algorithms will have different cryptographic strength and performance characteristics, and the use of any known cryptographic operation is within the scope of the described method.

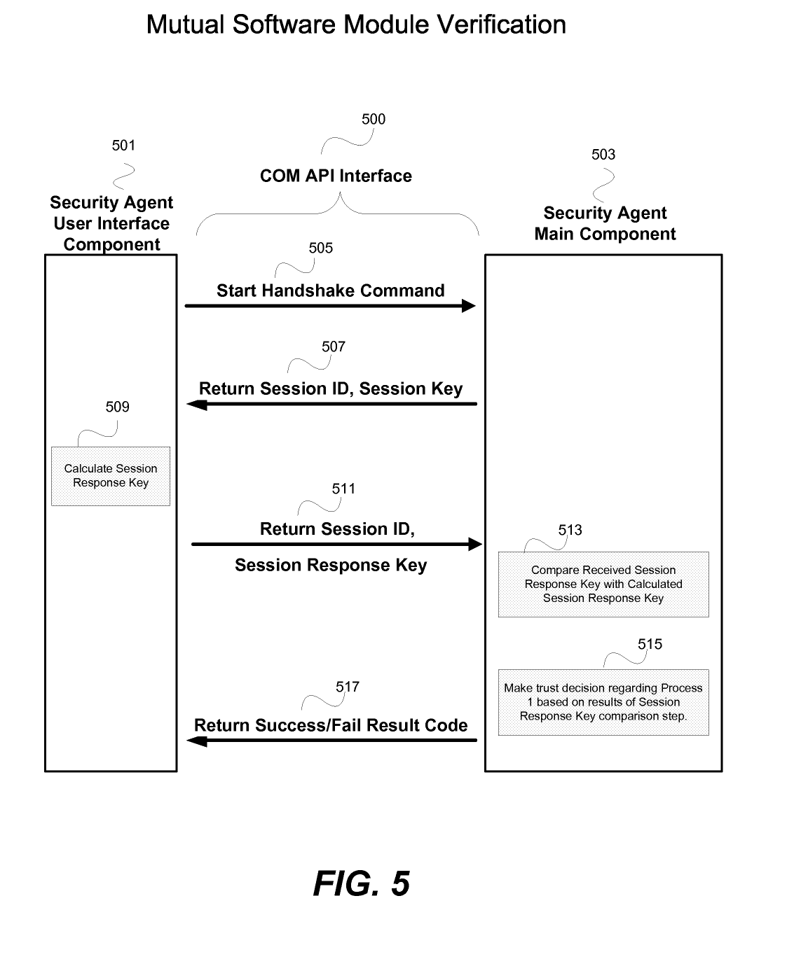

An exemplary logic flow for this three-step handshake sequence is shown in FIG. 5.

As shown in FIG. 5, communication is requested by a first software module, for example, security agent user interface component 501, and a second software module residing on the same computing device as the first software module, for example security agent main component 503. At step 505, security agent user interface component 501 can send a start handshake command 505 to the security agent main component 503 via the COM API interface 500 to establish communications between the two software components of the security agent. In response to the start handshake command 505, security agent main component 503 can provide the security agent user interface component 501 with a <SessionID, SessionKey> value pair to begin the authentication process. At step 509, security agent user interface component 501 can use the SessionKey to create a SessionResponseKey using a cryptographic function known only to it and the security agent.

Once the SessionResponseKey is created, in the second step of the authentication process, at step 511, security agent user interface component 501 can send the <SessionID, SessionResponseKey> pair to security agent main component 503. At step 513, security agent main component 503 can compute the expected SessionResponseKey for the given SessionID. If it matches the SessionResponseKey provided by the client, the client is authenticated, a reference to the interface can be returned, and normal communications between security agent user interface component 501 and security agent main component 503 can be permitted.

In the third step of the authentication process, if there is a match, security agent main component 503 can send a positive acknowledgment message to security agent user interface component 501, indicating successful completion of the handshake and a readiness to begin normal inter-component communications. If, however, there is no match, security agent main component 503 can conclude that security agent user interface component 501 does not know or does not have the correct cryptographic function and therefore is not a legitimate requester of services from security agent main component 503, and all requests from that module for access to the security agent would thereafter be blocked. Security agent main component 503 can then send a negative acknowledgment message to the software component that initiated the handshake and that is alleging its identity as security agent user interface component 501, indicating a failed handshake and indicating that inter-component communications will be blocked.

In accordance with other aspects, just as the security agent itself should be difficult to halt, so too should the monitoring process. For example, “stop” can be registered as a prohibited command by the monitoring process so that if a user or a command attempts to stop the monitoring process using an operating system command, the monitoring process will not be able to be stopped. Thus, in accordance with one or more aspects herein, the mechanisms described herein for protection of the security agent from attack can also be used to protect the monitoring process.

Moreover, since the monitoring process is protecting the security agent, the monitoring process is itself a potential target of attack. To increase the resiliency of the monitoring process, stealth techniques can be applied to make the monitoring process less visible to attackers and to make its purpose less obvious in order to protect the process and ensure its continued operation.

In one approach to protecting the monitoring process by making it stealthy, a process name that mimics the process name of some arbitrary common, important or innocuous software process, e.g. “msoffice,” “msoffice_accelerator,” “systembios,” “firefox_updater,” system_clock,” etc. can be used to name the process. Alternatively, a common operating system process name can be used, for example, names such as “svchost” or “svchost32” can be used on a Microsoft Windows-based operating system. An alternative approach is to use pseudo-random process names such that the purpose is not obvious, e.g. “f34f-vr33k”. Other names are also possible and can act to prevent a human or electronic attacker from recognizing the monitoring process as a process to be attacked, for example, as part of an attack on the device. Such naming conventions are well within the capability of modem operating systems.

If, however, despite the efforts described above, the security agent being monitored is disabled, the end point computing device is immediately vulnerable to abuse by end users or security attacks by attackers. During the period while the monitoring process tries to restart the affected security agents and to protect the end point device if the monitoring process cannot restart one or more security agents on the device, in accordance with one or more aspects and features described herein, the monitoring process can take other overt actions beyond simply trying to restart the security agent to protect the end point computing device from abuse or attacks.

In accordance with aspects herein, the monitoring process can take any one or more of several palliative actions. One objective of these actions is to prevent applications from running and/or to prevent network connectivity so that the device cannot present a threat or be threatened by other devices on a network.

One action that the monitoring process can take is preventing other software applications from starting or running if a monitored security agent is not running. Preventing general purpose software applications or security attack software applications from running helps to protect the end point from further attacks.

The mechanism for performing the application blocking varies by operating system. It generally involves maintaining a list of blocked applications, a rule for each regarding whether it is permitted or prohibited, and a default rule that is applied to all other processes not specifically found in the blocked applications list. The default action is usually either “that which is not expressly permitted is denied” or “that which is not expressly denied is permitted”. It may be necessary and beneficial to include a list of common operating system processes that should be permitted to remain running.

Therefore in accordance with one or more aspects described herein, the monitoring process can specify a list of specific applications that are not allowed to be run when one or more monitored security agents have been disabled. By default, any application not so enumerated is permitted to run when one or more security agents have been disabled. This is commonly known as a “blacklist approach.”

Alternatively, the monitoring process may be configured with a list of one or more specific applications that are permitted to be run when monitored security agents have been disabled. By default, any application not so enumerated is blocked from running when one or more security agents have been disabled. This is commonly known as a “whitelist approach.”

In addition, one skilled in the art would readily recognize that combinations of permitted and/or restricted applications are of course possible in accordance with aspects herein.

I accordance with aspects herein, if a monitored security agent is not running, the monitoring process can periodically query the operating system and can retrieve a list of running applications and processes. The list of currently running processes returned by the operating system can be compared against a predefined list of permitted/prohibited processes and a determination can be made by the monitoring process regarding whether any of the running processes should be halted. The monitoring process then can send a series of commands to the operating system to individually halt each undesirable process. The details of the operating system command and how they are sent will vary by operating system. For example a “net stop <process ID>” command in a Windows® operating system, or a “kill <process ID>” in a Linux® operating system will halt the running application.

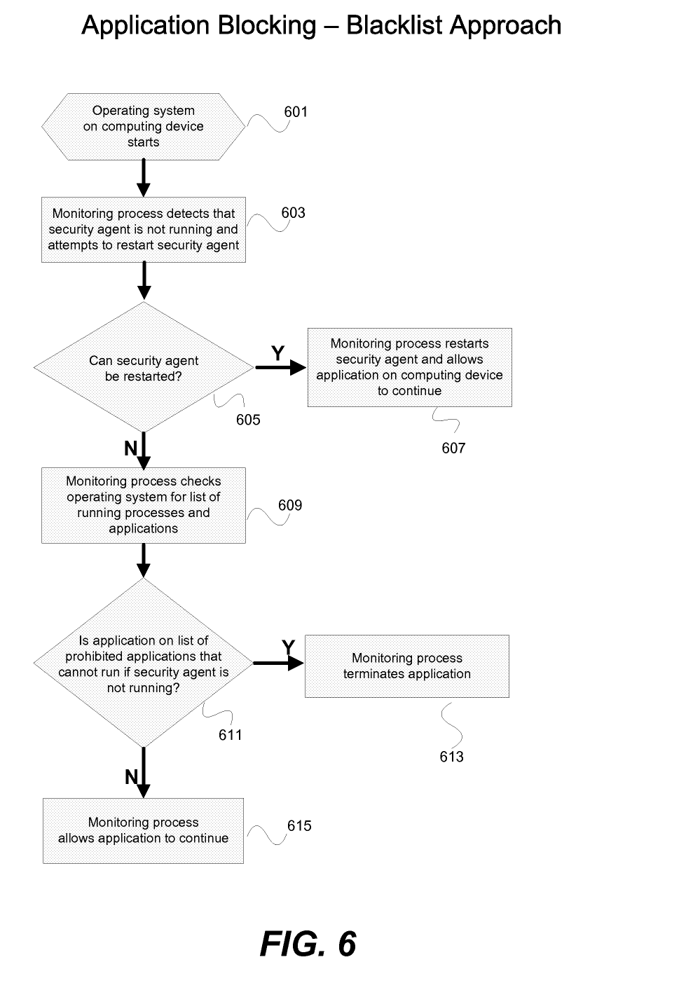

An exemplary logic flow in accordance with such aspects herein relating to a “blacklist” approach is shown in FIG. 6. As shown in FIG. 6, at step 601, an operating system, such as Microsoft Windows Vista® can start running on a computing device. Of course, one skilled in the art can appreciate that the aspects described herein can also be used with any other operating system such as other Microsoft® operating systems, Apple® OS-X, UNIX®, or Linux®-based operating systems. At step 603, the monitoring process detects that a security agent on the device is not running and attempts to restart the security agent, for example, as described above. At step 605, the monitoring process can check to see if the security agent can be restarted. If the answer at step 605 is “yes,” then at step 607 the monitoring agent can restart the security agent and can allow an application running on the computing device to continue. If the answer at step 605 is “no,” i.e., the security agent on the device cannot be restarted, then at step 609 the monitoring process can check a list of running processes to determine an identity of the processes and applications that are running on the device. For example, in accordance with one or more aspects herein, at step 611, the monitoring process can compare an identified process or application against a “blacklist” of applications that cannot run if a security agent is not running and can determine whether the identified process or application can continue even if the security agent is not running. If the answer at step 611 is “yes,” i.e., the application is a prohibited one, then at step 613 the monitoring process can terminate the application immediately, either with or without returning an error message indicating that the application cannot run. On the other hand, if the answer at step 611 is “no,” i.e., the application is not on the list of prohibited applications, then in accordance with the “blacklist” approach described above, at step 615 the monitoring process can allow the application to continue without interruption.

It is contemplated that in accordance with aspects herein, such a blacklist can vary depending on the nature of the security agent that is not running. For example, the blacklist can provide that a network connection application cannot run if a firewall application is not running but can run if the disabled application is an antivirus application. As another example, the blacklist can provide that a financial management application cannot run if a spyware protection security agent is not running, but can run if the disabled application is a firewall application.

In addition, if the operating system receives a command to start an application that is on the list of prohibited applications at a time when a security agent is disabled or otherwise has stopped running, in accordance with aspects described herein, the monitoring process can instruct the operating system to block the initialization of the requested application, with or without an error message being displayed to a user.

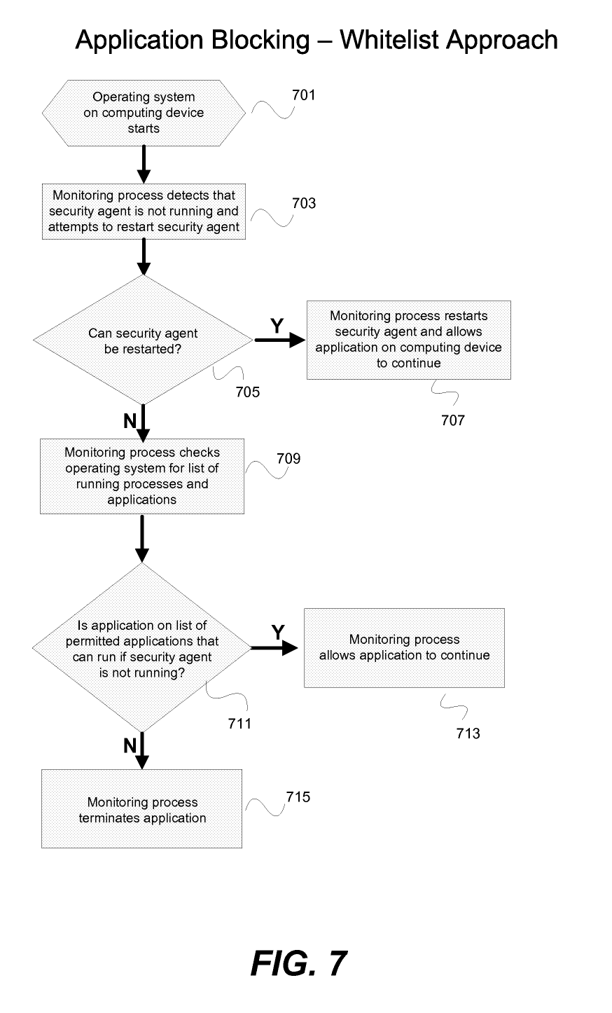

An exemplary logic flow for an alternative embodiment in accordance with a “whitelist” approach is shown in FIG. 7. As shown in FIG. 7 the operating system on a computing device can start at step 701. As discussed above, the operating system can be a Microsoft Windows® operating system or any other operating system known in the art. At step 703, the monitoring system can detect that a security agent on the device is not running and as discussed above can attempt to restart the security agent, for example, in a manner in accordance with aspects discussed herein. At step 705, the monitoring process can determine whether the security agent can be restarted. If the answer at step 705 is “yes,” i.e., the security agent can be restarted, then in a manner similar to that discussed above with respect to FIG. 6, at step 707 the monitoring agent can restart the security agent and can allow an application running on the computing device to continue. If, however, the answer at step 705 is “no,” i.e., the security agent on the device cannot be restarted, then at step 709 the monitoring process can check a list of running processes to determine an identity of the processes and applications that are running on the device. In accordance with one or more aspects herein, at step 711, the monitoring process can compare an identified process or application against a “whitelist” of applications that can run if a security agent is not running and can determine whether the identified process or application can continue even if the security agent is not running. If the answer at step 711 is “yes,” i.e., the application is a permitted application, then at step 713 the monitoring process can allow the application to continue without interruption. On the other hand, if the answer at step 711 is “no,” i.e., the application is not on the list of permitted applications, then in accordance with the “whitelist” approach described above, at step 715 the monitoring process can terminate the application immediately, with or without an error message to a user.

In a manner similar to the “blacklist” approach described above, it is contemplated that such a whitelist can vary depending on the nature of the security agent that is not running. For example, the whitelist can provide that a word processing application can run if a firewall application is not running but cannot run if the disabled application is an antivirus application. As another example, the whitelist can provide that a financial management application can run if an antivirus application security agent is not running, but cannot run if the disabled application is a spyware protection security agent.

In addition, if the operating system receives a command to start an application that is not on the list of permitted applications at a time when a security agent is disabled or otherwise has stopped running, in accordance with aspects described herein, the monitoring process can instruct the operating system to block the initialization of the requested application, with or without an error message being displayed to a user.

In the event that a user or attacker is able to successfully circumvent all security mechanisms built into the protected software process such as those described above, the monitoring process can send a command, for example, to the operating system or an external security application such as a personal firewall, to immediately block all inbound and/or outbound network traffic. While this action does not restore the protected software process, it can prevent a vulnerable computer from being subsequently used for network communications and so subsequently attacked from a remote computing device. More importantly, it can immediately cut off and thus prevent communications between the computing device and a remote attacker communicating across a network.

This end result can be achieved in a number of different ways, the details of which will vary by operating system.

One approach in accordance with aspects herein can apply an access control list (ACL) that specifies source and destination computing devices the local computing device is permitted to communicate with. In this situation, an ACL that completely blocks all inbound and/or outbound data communications could be used. An alternative ACL is one that only permits data communications with specific security applications or servers on the network running specific security applications.

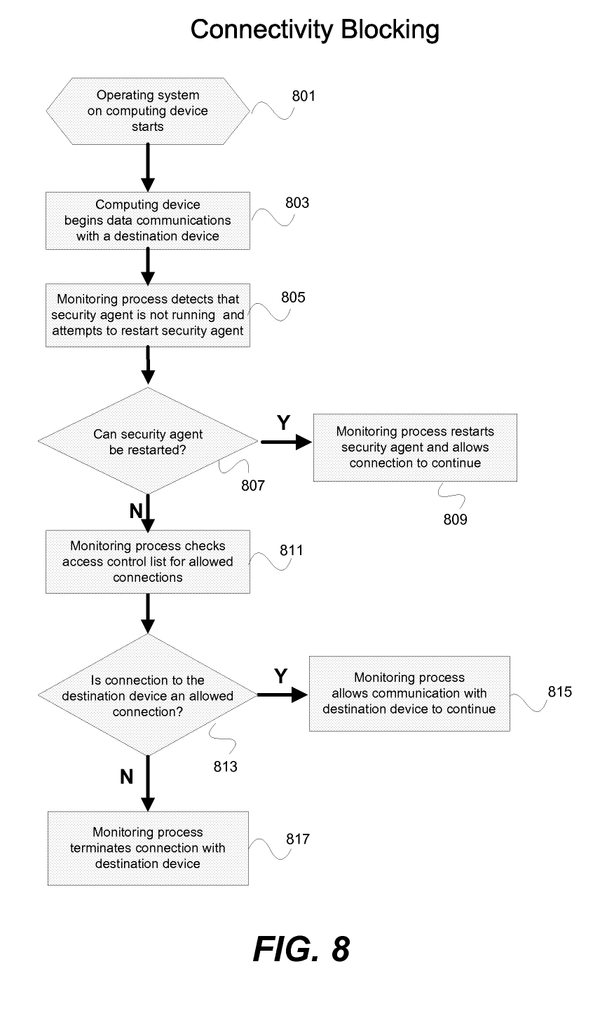

An exemplary logic flow in accordance with these and other aspects described herein is shown in FIG. 8. As shown in FIG. 8, at step 801, an operating system can start on a computing device. As discussed above, the operating system can be a Microsoft® operating system such as Microsoft Windows XP® or Microsoft Windows Vista®, a UNIX®-based operating system, or a Linux®-based operating system such as Ubuntu®, or Red Hat Linux®. At step 803, the computing device can begin data communications with a destination device, such as a network server or a second computing device over a network. Such data communications can be by any connection protocol known in the art for communication between multiple computing devices or a computing device and a network server. For example, communications can be by wired or wireless communication and can be over a local area network or a virtual private network. At step 805, the monitoring process can detect that a security agent such as a firewall application or an antivirus application is not running and attempts to restart the security agent, for example, in a manner as described above. At step 807 the monitoring agent can check to see whether the security agent can be restarted. If the answer at step 807 is “yes,” i.e., the security agent can be restarted, then at step 809 the monitoring process restarts the security agent and allows the connection between the computing device and the destination device to continue. If, however, the answer at step 807 is “no,” then at step 811 the monitoring process determines whether the connection between the computing device and the destination device can continue, for example, by checking an access control list (ACL) to determine an identity of connections that are allowed to continue if a security agent on the computing device fails.

It is contemplated that in accordance with aspects herein, an ACL can comprise several lists, and whether a connection to a destination device is an allowed connection can vary depending on an identity and/or a nature of a security agent that is not running. For example, a connection to a network server can be an allowed connection if an antivirus application is not running but can be disallowed if the security application that is not running is a firewall application. Alternatively, the ACL can provide different levels of access that can be allowed depending on the nature of the security agent that is not running. For example, the ACL can allow incoming data to flow to the computing device from a destination device such as another computer or a server but not allow outbound data to flow from the computing device. In this way, the operability of the computing device can be maintained in accordance with the level and type of security vulnerability presented by the device.

Thus, at step 813 based on the check of the ACL at step 811, the monitoring process can determine whether the connection of the computing device to the destination device is an allowed connection, based on the type of connection and the type of security vulnerability presented. If the answer at step 813 is “yes” for any of the reasons described above, then at step 815 the monitoring process can allow the connection between the computing device and the destination device to continue without interruption. If, however, the answer at step 813 is “no,” then at step 817 the monitoring process can immediately terminate the connection between the computing device and the destination device in order to protect one or both of the computing device and the destination device from security threats that the failure of the security agent might present. In accordance with aspects herein, upon termination of the connection, the monitoring process can display a message to a user advising that the connection has been terminated, for example, so that the user can know to take remedial steps to restore the security agent to an operational status.

Other approaches to disrupting network communications capabilities are possible to protect one or both of a computing device and a destination device in accordance with aspects and features described herein.

For example, in accordance with aspects herein, the monitoring process can set the time-to-live (TTL) value on all outbound packets from the computing device to the destination device to zero. As defined in IETF RFC 791, Internet Protocol (IP), when an intermediate network packet processing device or a destination computing device receives an IP packet with a TTL value set equal to zero, that destination device is required to discard the IP packet altogether. Thus, if the TTL value in all outbound IP packets is set to zero, all IP packets transmitted by the computing device can be discarded immediately upon reaching the first IP packet processing device, e.g. a router or a switch/router. Although messages technically can still be received in this situation, no response will ever be received to commands or requests received across the network, making it impossible for a remote computing device to know if it is successfully communicating with the target computing device and making it impossible to use certain communication protocols that require an acknowledged session setup before data communications can proceed, e.g. Transport Control Protocol (TCP), as defined in IETF RFC 793. Such an approach can also be used to set a TTL value to zero for all incoming packets to the computing device so that the computing device can be protected from outside threats. As noted above, one or the other, or both, of these approaches can be employed as necessary to protect the computing device and any destination devices, depending on the nature of the security agent that is inoperative.

In an alternative embodiment, the monitoring process can make changes to the end point's Domain Name Service (DNS) settings such as clearing the current configuration setting for DNS server, placing static entries in the computing device's network hosts file, or programmatically changing a rule on a firewall via an application programming interface (API) or other mechanism. This would cause DNS hostname resolution queries to essentially fail, making network communications based on DNS hostnames impossible.

In another alternative embodiment, the monitoring process can remove or change a configuration value (normally an IP address) default gateway IP address in the Address Resolution Protocol (ARP) cache or wherever else that parameter might be stored or available on the end point computing device. This would cause outbound packets to be not sent at all or alternatively sent to an incorrect destinationIP address, resulting in a communications failure.

In still another alternative embodiment, the monitoring process can forcibly release dynamically assigned (e.g. via DHCP) IP addresses on one or more network adapters or can remove or modify statically configured IP addresses on all network adapters. Under this approach, without an IP address, a computing device will be unable to perform IP-based network communications.

In an alternative embodiment, the monitoring process can forcibly disable the network adapter by sending an appropriate command to the operating system. By logically disabling the network adapter, all network communications into and out of the computing device via that network adapter is effectively blocked.

Combinations of the above are all possible and all within scope of aspects described herein. In addition, in accordance with aspects described herein, simultaneous use of a combination of mechanisms such as described can create a situation in which the collective effort required to restore network connectivity is very high, and ideally insurmountable by a user or attacker. While any one of these mechanisms could be undone, each requires very specific knowledge of networking, communications protocols and how to inspect and configure network-related configuration settings in the operating system. Such expertise is well above the knowledge level of most users and many attackers.

The techniques just described are IP-centric, i.e. they are targeted towards disrupting use of the IP protocol, and hence disrupt network traffic using the IP protocol. Similar techniques could be applied to disrupt other network communications protocols in use on the end point computing device.

The invocation of these actions just described can be triggered by the security agent itself in the event it detects any unauthorized attempt to shut it down. In the event the security agent is successfully disabled and was unable to perform one or more of the actions just described, the security agent's partner monitoring process will detect the security shutdown event and can invoke any or all of these actions on the security agent's behalf, in lieu of or in addition to trying to restart and restore the security agent process to a normal operational state.

Although described in terms of both software and hardware components interactively cooperating, it is contemplated that security agent monitoring and protection systems and methods as described herein can be practiced entirely by use of software. Such software can be embodied in a computer-readable medium such as a magnetic or optical disk that can include computer program instructions that can cause a computer to implement one or more of the monitoring and protection methods described herein. Alternatively, such software can be embodied in a radio-frequency or audio-frequency carrier wave.

Although particular embodiments, aspects, and features have been described and illustrated, it should be noted that the invention described and claimed herein is not limited to only those embodiments, aspects, and features. It should be readily appreciated that modifications may be made by persons skilled in the art, and the present application contemplates any and all modifications within the spirit and scope of the underlying invention described and claimed herein. Such embodiments are also contemplated to be within the scope and spirit of the present disclosure.

What is claimed is:

1. A method of protecting a security status of a computing device, comprising:
determining whether a security agent on said computing device is running;
if said security agent is not running, determining whether said security agent can be restarted;
restarting said security agent if said security agent can be restarted;
if said security agent cannot be restarted, checking an identity of an application running on said computing device to determine whether said application can run if said security agent is not running; and
terminating said application if said application cannot run if said security agent on said computing device is not running.

2. The method according to claim 1, further comprising:
checking a blacklist of prohibited applications that cannot run if said security agent on said computing device is not running, said blacklist being maintained in a memory in said computing device;
allowing said first application to continue if said application is not on said blacklist of prohibited applications; and
terminating said application if said application is on said blacklist of prohibited applications.

3. The method according to claim 2, wherein said blacklist of prohibited applications depends on a characteristic of said security agent not running on said computing device.

4. The method according to claim 1, further comprising:
checking a whitelist of permitted applications that can run if said security agent on said computing device is not running, said whitelist being maintained in a memory in said computing device;
allowing said application to continue if said application is on said whitelist of permitted applications; and
terminating said application if said application is not on said whitelist of prohibited applications.

5. The method according to claim 4, wherein said whitelist of permitted applications depends on a characteristic of said security agent not running on said computing device.

6. The method according to claim 1, wherein said determination whether said application should be terminated depends on a characteristic of said security agent that is not running on said computing device.

7. The method according to claim 1, wherein said terminated application is a communications application for facilitating data transfer between said computing device and a destination device.

8. A method of protecting a security status of a computing device, comprising:
receiving a request to start an application on said computing device;
determining whether a security agent on said computing device is running;
if said security agent is not running, determining whether said security agent can be restarted;
restarting said security agent if said security agent can be restarted; and
starting said application if said security agent is running.

9. The method according to claim 8, further comprising:
checking a blacklist of prohibited applications that cannot run if said security agent on said computing device is not running, said blacklist being maintained in a memory in said computing device; and
allowing said application to start if said application is not on said blacklist of prohibited applications.

10. The method according to claim 9, wherein said blacklist of prohibited applications depends on a characteristic of said security agent not running on said computing device.

11. The method according to claim 8, further comprising:
checking a whitelist of permitted applications that can run if said security agent on said computing device is not running, said whitelist being maintained in a memory in said computing device; and
allowing said application to start if said application is on said whitelist of permitted applications.

12. The method according to claim 11, wherein said whitelist of permitted applications depends on a characteristic of said security agent not running on said computing device.

13. The method according to claim 8, wherein said determination whether said application should be started depends on a characteristic of said security agent that is not running on said computing device.

14. A monitoring process for protecting a security status of a protected application on a computing device, comprising:
a monitoring agent on said computing device, said monitoring agent on said computing device and being adapted to monitor a status of said application; and
at least one configuration file, said configuration file residing in memory on said computing device, said configuration file further including information regarding a prohibited command associated with said application;
wherein said monitoring agent monitors said application to ensure that said prohibited command is not executed with respect to said application.

15. The monitoring process of claim 14, wherein said protected application is a security agent on said computing device.

16. The monitoring process of claim 15, wherein said prohibited command is a command to stop said security agent.

17. The monitoring process of claim 16, wherein said monitoring agent is adapted to restart said security agent if said security agent is stopped.

18. The monitoring process of claim 15, wherein said prohibited command is a command to modify said security agent.

18. The monitoring process of claim 18, wherein said monitoring agent is adapted to restore said security agent to an initial state if said security agent is modified.

20. The monitoring process of claim 14, wherein said monitoring agent is adapted to receive information of a software module associated with said protected application, determine a value of a first characteristic of said software module, receive information of an expected value of said first characteristic of said software module, and compare said determined value of said first characteristic with said received expected value;
wherein said software module can be loaded for execution by said protected application if said determined value conforms to said expected value.

21. The monitoring process of claim 14, wherein said monitoring agent is not identifiable as being associated with said protected application.

22. The monitoring process of claim 21, wherein said monitoring agent comprises at least one software module identified by an alternate identifier not associated with said protected application.

23. The monitoring process of claim 21, wherein said monitoring agent comprises at least one software module identified by a pseudo-random identifier.

24. A method for protecting a security agent on a computing device, comprising:
receiving information of an initial value of a file permission for said security agent, said initial value of said file permission being established upon initialization of said security agent on said computing device;
storing said initial value of said file permission in memory in said computing device,
receiving information of a current value of said file permission for said security agent;
comparing said current value of said file permission to said initial value; and
resetting said current value of said file permission to said initial value if said current value does not match said current value.

25. A method for protecting a security agent on a computing device, comprising:
receiving information regarding a first software module being loaded into memory for execution on the computing device, said first software module being a software module associated with said security agent;
determining a first characteristic of said first software module;
receiving information regarding a first value of said first characteristic from memory in said computing device, said first value being an expected value of said first characteristic;
receiving information regarding a second value of said first characteristic;
comparing said second value to said first value; and
loading said first software module into memory for execution if said second value matches said first value.
